(19) United States
(12) Patent Application Publication
(10) Pub. No.: US 2006/0007152 A1
(43) Pub. Date: Jan. 12, 2006

(54) Computer finger mouse

(76) Inventor: Yuguang Wang, Mesa, AZ (US)

Correspondence Address: Yuguang Wang, 2606 S. Saratoga Ave., Mesa, AZ, 85202, US

(21) Appl. No.: 11/172,761

(22) Filed: Jul. 2, 2005

Related U.S. Application Data
(60) Provisional application No. 60/586,044, filed on Jul. 7, 2004.

(51) Int. Cl. G09G 5/08

(52) U.S. Cl. 345/163

(57) ABSTRACT

A computer finger mouse includes a concave structure for embrace the fingertips of a hand in a relaxed positions. The concave structure allows the mouse be held and manipulated by the fingertips of a hand only. A hand holding and manipulating the computer finger mouse is in a naturally relaxed and curled position, without requiring static twisting of the hand, wrist, or forearm. As a result, fatigue, discomfort, and pain are minimized or eliminated even after a long period of continuous use.

### BACKGROUND OF THE INVENTION-PRIOR ART

Many software programs use movable cursors for selecting data and objects or drawing on a display monitor. The cursors are generally controlled by a manually manipulated pointing device connected to a computer. Common pointing devices include the mouse, trackball, touch pad, and digitizing tablet.

The mouse is the most popular pointing device. It includes a housing that is slidably moved about on a flat, stationary surface. The housing contains a motion sensor on its bottom side for tracking its movement, one to three buttons on its front edge, and electronic circuitry for communicating with an attached computer. When the mouse is moved about, the cursor moves in corresponding directions; and when the buttons are pressed, certain actions can be performed, depending on the software application using the mouse. The internal parts, and electrical and software operations of computer mice are well known in the art.

Most mice, such as the one shown in U.S. Pat. No. D302,426 to Bradley et al., are substantially wider than they are tall, and have generally symmetrical sides so that they can be used by either the right or the left hand. Some mice are specially shaped for providing an optimal fit for a user's right hand. The mouse shown in U.S. Pat. No. D328,597 to Clouss, and sold under the trademark “MouseMan” by Logitech Inc. in Fremont, Calif., has a slightly angled but generally horizontal top surface for supporting the fingers and palm of a right hand. The Microsoft Mouse, Version 2, sold by Microsoft Corporation in Redmond, Wash., includes a concave left side for closely engaging the base of the thumb and palm of a right hand. The mouse shown in U.S. Pat. No. 4,862,165 to Gart includes a surface for supporting some fingers in substantially curled positions. Some ergonomic mice, including the Logitech MouseMan™, are also made in left-handed versions.

All prior art mice have a generally horizontal, primary supporting surface for supporting a hand in a horizontal position, as exemplified by the drawing figures of U.S. Pat. No. 5,157,381 to Cheng, and the drawings in the user's manual of the Microsoft Mouse. The mice in the prior art require using both thumb and the fingers of a hand to hold the edges of left and right side of the mouse. Because the prior art mice require be hold on the both edges of left and right sides, therefore prior art mice force the hand, wrist, and forearm to be twisted out of their natural and relaxed positions, and require constant muscular force to be applied to the hand, wrist, and forearm to maintain their positions. For a three-button mouse, the fore, middle, and ring fingers must be kept in constant tension to prevent them from resting too heavily on the buttons and depressing them inadvertently. To avoid twisting the wrist when holding a computer mouse, an ergonomic computer mouse shown in U.S. Pat. No. 5,576,733 to Lo has chosen a bell-like shape. The hand holds the mouse within a loose fist and is in an upright position: the little finger side of the hand rests on the desk, and the fingers and palm generally define a vertical plane. This position eliminates the deviation of a wrist when the hand holds the mouse in a static state. But this position can not take advantage the flexibility and mobility of fingers and their joints. It also shortens the distance between the mouse and the wrist. The wrist and the forearm have to swing to left or right, move forward or backward harder to produce needed mouse movement.

### BACKGROUND OF THE INVENTION-OBJECT AND SUMMARY

Accordingly the primary object of the present invention is to provide an ergonomic computer mouse which is shaped to allow a hand holding and manipulating it to remain in a natural, untwisted, and relaxed position. Another object of the invention is to provide an ergonomic computer finger mouse which minimizes or eliminates fatigue, discomfort, and pain even after prolonged and continuous use. Further objects and advantages of the invention will become apparent from a consideration of the drawings and ensuing description. These and other objects are achieved with an unique computer finger mouse having a concave finger-supporting structure for holding the mouse on a flat surface by using the fingertips of a hand only without needing help from the thumb.

This method of holding and manipulating a computer mouse fully takes advantage of the flexibility and mobility of human fingers. A computer mouse is moved forward or backward by stretching out or curling the fingers, respectively. This makes handling computer mouse a relaxation than a stress.

### BRIEF DESCRIPTION OF THE DRAWINGS

FIG. 1 is a perspective view of the computer finger mouse in accordance with the first embodiment of the invention.

FIG. 2 is a top plane view of the computer finger mouse of FIG. 1, and

FIG. 3 is a top plane view of a user's hand engaging with the computer finger mouse of FIG. 1, and

FIG. 4 is a left side elevational view of the computer finger mouse of FIG. 1, and

FIG. 5 is a left side elevational view of the computer finger mouse of FIG. 1 with an alternative extra button added, and

FIG. 6 is a front side elevational view of the computer finger mouse taken from line 6 of FIG. 2, and

FIG. 7 is a rear side elevational view of the computer finger mouse taken from line 7 of FIG. 2, and

FIG. 8 is a vertical sectional view of the computer finger mouse taken along the line 8-8 of FIG. 2, and

FIG. 9 is a vertical sectional view of the computer finger mouse taken along the line 9-9 of FIG. 2, and

FIG. 10 is a vertical sectional view of the computer finger mouse taken along the line 10-10 of FIG. 2.

FIG. 11 is a perspective view of the computer finger mouse in accordance with the second embodiment of the invention.

FIG. 12 is a top plane view of the computer finger mouse of FIG. 11, and

FIG. 13 is a top plane view of the computer finger mouse in accordance with the third embodiment of the invention.

FIG. 14 is a left side elevational view of the computer finger mouse of FIG. 13.

### DESCRIPTION OF THE INVENTION

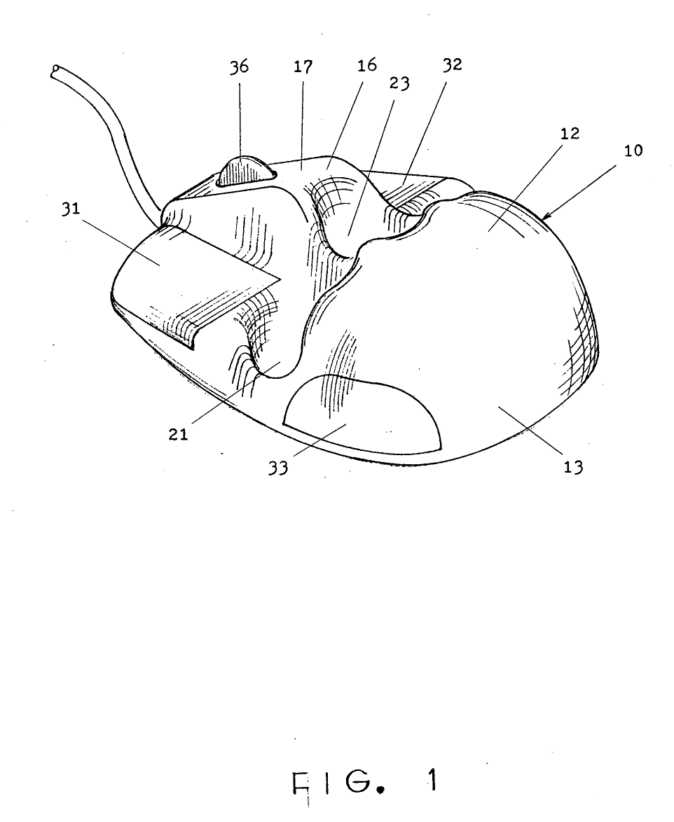

Turning now to the drawings, in which like reference characters indicate corresponding elements throughout the several views, attention is first directed to FIG. 1 in which is seen a computer finger mouse 10 having a upper body with generally oval shaped contour, a concave structure across middle portion of the upper body laterally, several buttons, a scroll wheel, and a horizontal flat bottom surface.

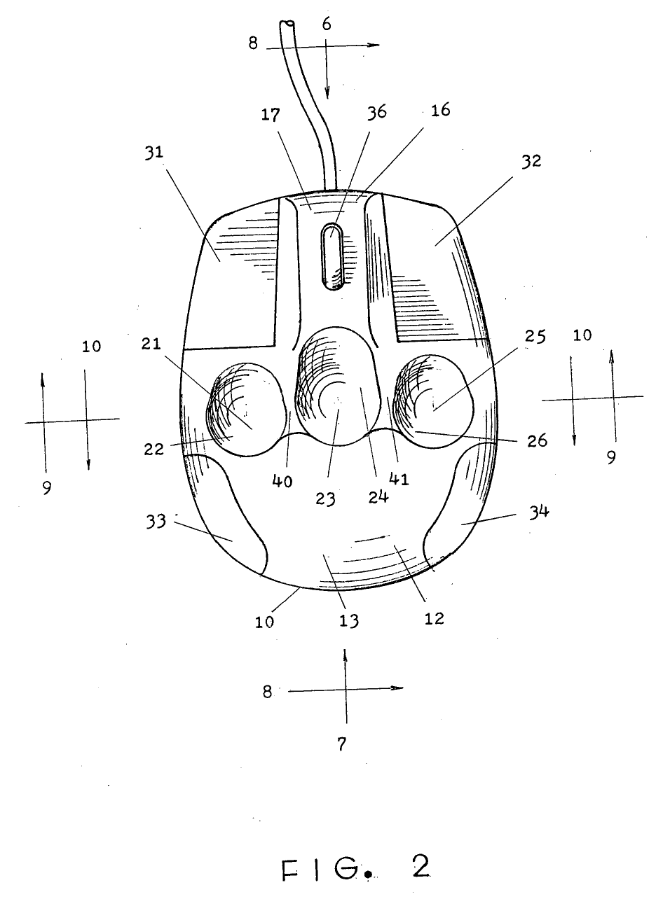

As further seen in FIG. 2 in which is seen the computer finger mouse 10 including a front upper body 16 having surface 17, a rear upper body 12 having surface 13. A concave structure includes three finger spaces, finger space 21, finger space 23 and finger space 25. Finger space 21 having surface 22, finger space 23 having surface 24, and finger space 25 having surface 26 are disposed across the middle of the upper body laterally, between the front upper body 16 and rear upper body 12. Finger space 22 and finger space 23 is separated by member 40. Finger space 23 and finger space 25 is separated by member 41. Scroll wheel 36 is located at the middle of front upper body 16. Buttons 31 is located on left side of front upper body 16 extended between the upper-left edge of 16 and the edge of finger space 21. Buttons 32 is located on right side of front upper body 16 extended between the upper-right edge of 16 and the edge of finger space 25. Button 33 is located on the left edge of rear upper body 12. Button 34 is located on the right edge of rear upper body 12. The upper body, the buttons, and the scroll wheel and the mouse bottom surface can be manufactured using the same materials and processes as those of the conventional prior art computer mice.

FIG. 3 demonstrates the preferred mode of using the computer finger mouse 10. The right-handed user(s) insert the index fingers 51 into finger space 21, the middle finger 53 into finger space 23, and the ring finger 55 into finger space 25, respectively. The small finger can rests wherever users like. All the fingers are curled naturally with the fingertips nearly perpendicular to the surface on which the finger mouse is rested. The thumb is bent naturally and rested on the same surface on which the finger mouse is rested. In this position, the fingers, the hand, and the forearm are aligned. All the joints of fingers, thumb and wrist are in the comfortable neutral states without any biased twist applied. To manipulate the finger mouse, with slight downward pressure from the fingertips, the mouse 10 can be moved forward by stretching out the fingers and moved backward by curling the fingers further without moving any other body part. The above stretching and curling the fingers are the most easy and natural movements of human body. It is more like a relaxation than a stress. The lateral movement of finger mouse 10 can be realized by swing the hand and the forearm to the left or to the right, respectively. The distance from the wrist to the fingertips is longer than the distances from the wrist to the thumb tip or center of palm. To swing a finger mouse hold by the fingertips will require less movement of wrist and forearm than the prior art mice which are hold between thumb and fingers or hold in the palm. Less movement for the wrist and the forearm means less stress, less fatigue and less damage. When it is necessary, the thumb can move inward to press the button(s) disposed at the edge of the rear upper body. Because of the symmetrical structure and shape of mouse 10 along the line 8-8 of FIG. 2, the left-handed users can use the mouse the same way as the right-handed users. Although the above mode of using the mouse is preferred, user can choose holding the mouse between the thumb and fingers and manipulating it the same way as using the conventional prior art mice.

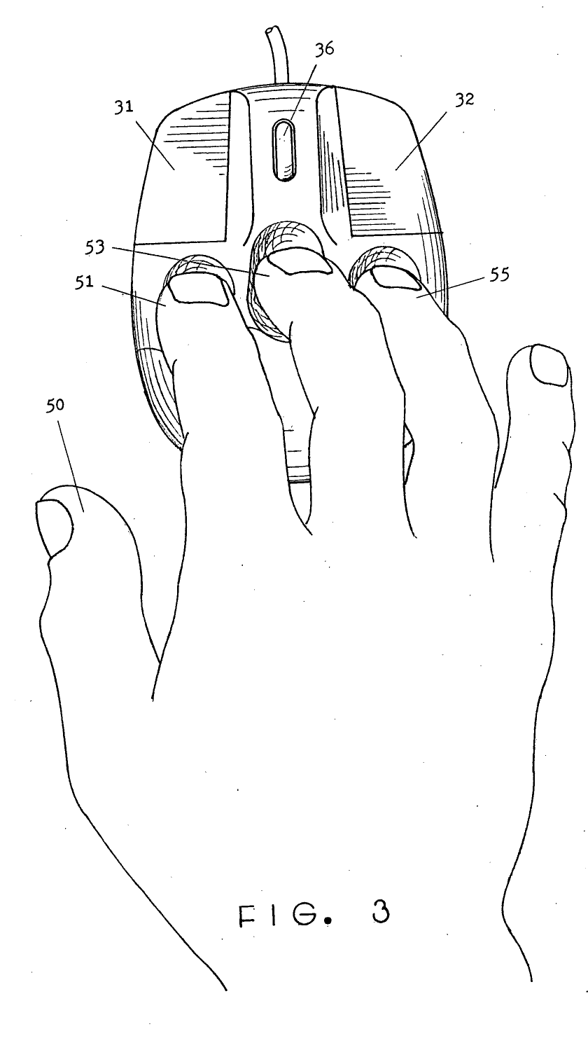

In the left elevational view of FIG. 4 finger space 21 with part of surface 22 can be seen. Finger space 23 is hiding behind member 40. The button 31 is extended at the edge of finger space 21 and can be easily reached by stretching out the index finger just like using the prior art mice. Button 33 is located at the left edge of rear body and can be easily reached by moving the thumb inward. And this movement of thumb is natural and with little stress. The scroll wheel 36 can be seen at middle of front body 16.

FIG. 5 is the left elevational view of an alternative embodiment of the invention. An extra button 37 is added next to button 33 as shown. If button 33 serves as the left-click button of a conventional computer mouse, button 37 can serve as the right-click button, and vise versa Similarly, an extra button 38 can be added next to the button 34, opposite to button 37.

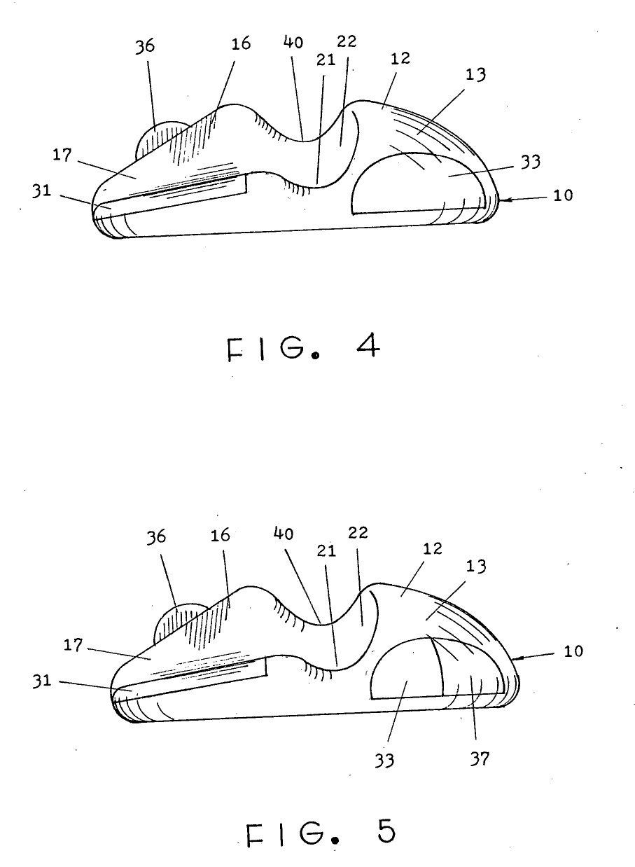

FIG. 6 and FIG. 7 depict the symmetrical shape and structure of finger mouse 10 from both front and rear side elevational views.

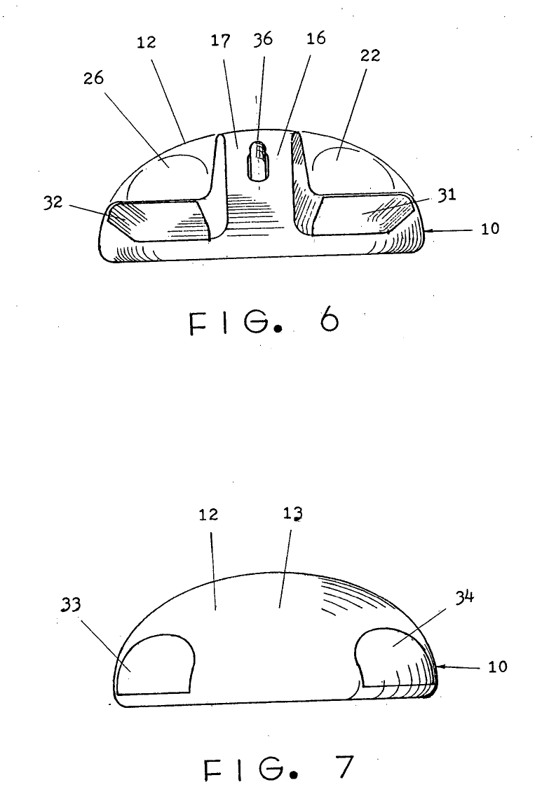

As further seen in FIG. 8, the finger space 23 has a nearly V shaped vertical sectional view. Small circumstance at the bottom of finger spaces is for embracing the fingertips and big circumstance at top is to make the fingertips comfortable when the fingers are stretched out or curled. The surface of finger space 22 can be covered with tiny goose bump or wove paper like structures to make it coarse. And those structures can be made of same material as the finger mouse body or soft rubber, plastics or fibers. The vertical sectional views of finger space 21 and finger space 25 have the same shapes as that of finger space 23. The surfaces of finger space 21 and 25 also have same shapes and features as those of finger space 23. A scroll wheel 36 is located at middle of front body surface 17.

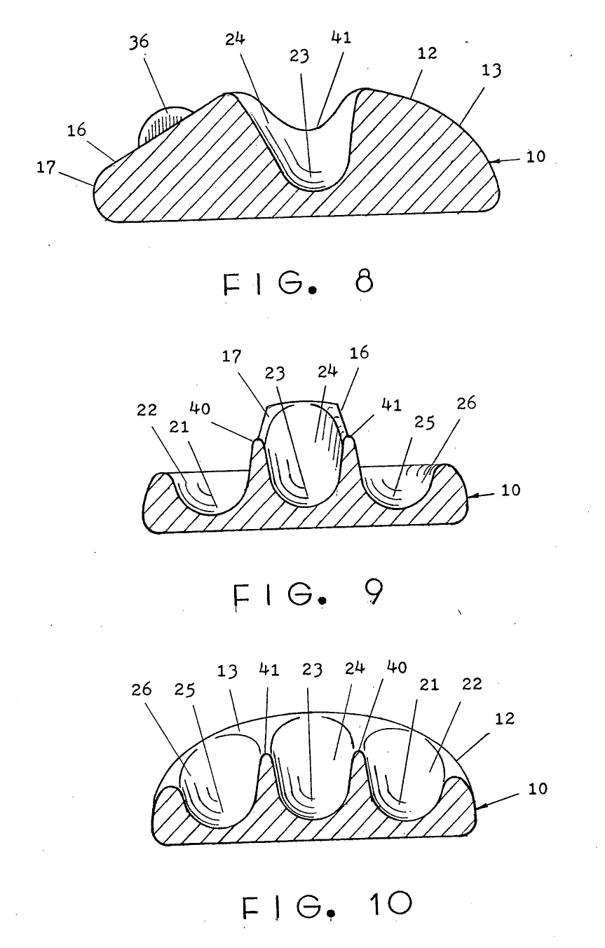

FIG. 9 and FIG. 10 further depict the shapes and positions of finger space 21, 23, and 25. Round shapes at bottoms of finger space 21, 23, and 25 accommodate the shape of users fingertips. Elevated member 40 and 41 will make holding and manipulating the mouse more secure.

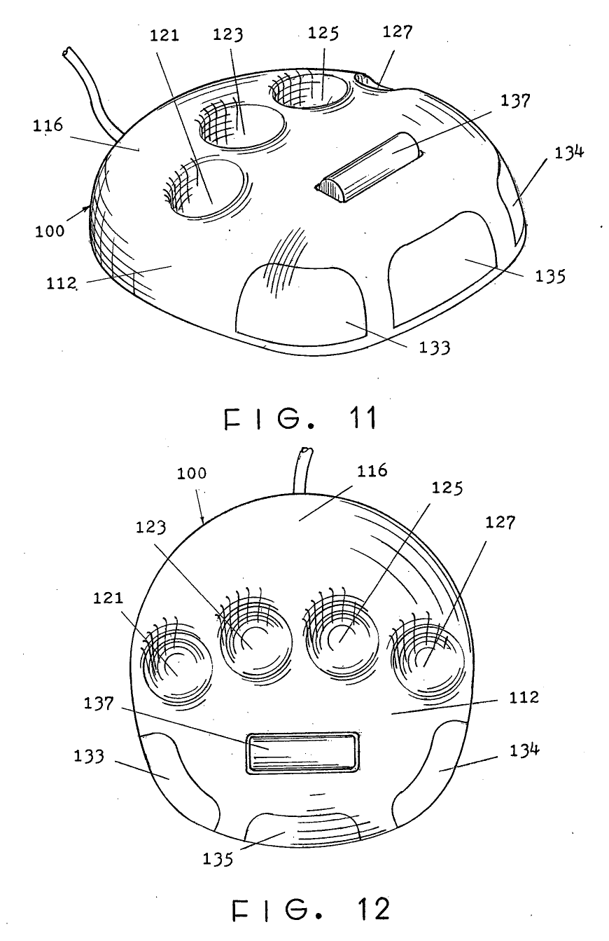

FIG. 11 is a perspective view of the computer finger mouse 100 in accordance with the second embodiment of the invention. The computer finger mouse 100 including a front upper body 116, a rear upper body 112. A concave structure includes four finger spaces, finger space 121, finger space 123, finger space 125 and finger space 127. Finger space 121, finger space 123, finger space 125 and finger space 127 are disposed across the middle of the upper mouse body laterally, between the front upper body 116 and rear upper body 112. Button 133 is located on the left edge of rear upper body 112. Button 134 is located on the right edge of rear upper body 112. Button 135 is located on the lower middle edge of rear upper body 112. Scroll wheel 137 is located at the middle of rear upper body 112. The mouse body, the concave structure, the buttons, and the scroll wheel can be manufactured using the same materials and processes as those of the conventional prior art computer mice and computer finger mouse 10 in FIG. 1.

FIG. 12 is the top plane view of computer finger mouse of FIG. 11. The four finger spaces have the similar shapes and features of finger spaces on finger mouse 10 in FIG. 1. They can be made of same material as that of upper body or can be made of soft, flexible material for better fingertips embracing. The four finger spaces can be arranged and shaped for right-handed users or left-handed users only. They also can be made symmetrical for both right-handed and left-handed users. The way to hold and manipulate finger mouse 100 is similar to that of finger mouse 10. For right-handed users, if button 133 is treated as left button, then button 135 will be treated as right button and vase versa. For left-handed users, button 134 and button 135 will be used as right and left button combination. All the buttons on finger mouse 100 are designed for the thumbs only. So is the scroll wheel 17.

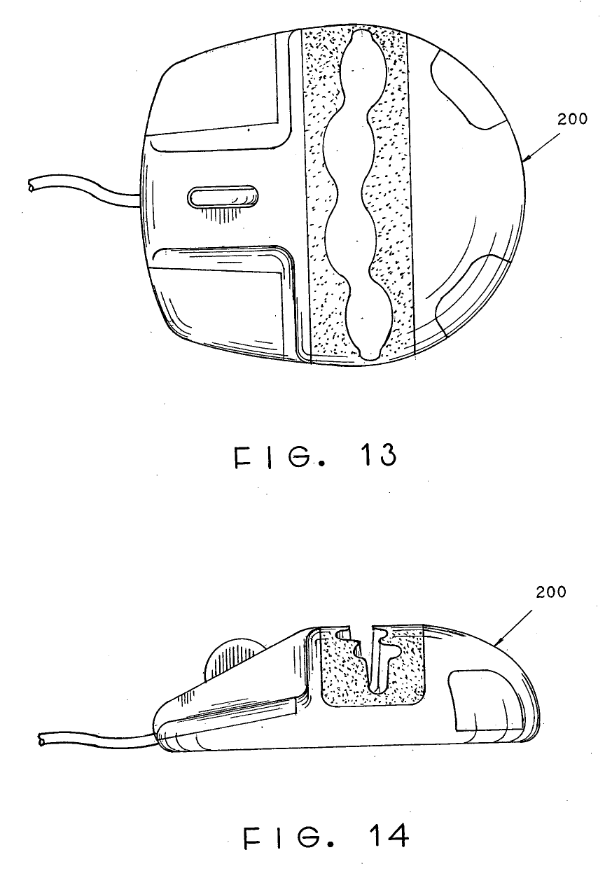

FIG. 13 and FIG. 14 give the top plane view and left elevational view of the computer finger mouse 200 in accordance with the third embodiment of the invention. Finger mouse 200 is almost identical to finger mouse 10 except the shape of finger spaces. Instead of having separated finger spaces, finger mouse 200 has a concave structure containing a narrow and continuous finger space for all fingers. The concave structure is made of soft and flexible material for better embracing the fingertips. The concave structure of finger mouse 200 can be made symmetrical for both right-handed and left-handed users. It also can be made for right-handed or left-handed users only. Finger mouse 200 is handled the same way as that of finger mouse 10.

Conclusion, Ramifications, and Scope

Accordingly the concave structure of the computer finger mouse, in all embodiments, allows the finger mouse to be held and manipulated mainly by the fingertips of a hand only. The hand remains in a relaxed and naturally curled position. It eliminates the substantial twisting of the hand, wrist, and forearm that are common to users of prior art mice. The naturally curled position hand distributes its weight between its fingertips and lower palm (FIG. 3), which eliminates the pressure sores on the wrist that prior art mice can cause. As a result, fatigue, discomfort, and pain are minimized or eliminated even after a long period of continuous use.

The present invention only relates to the ergonomic aspects of a computer mouse. It can employ any electronic communication and motion sensing technologies well known in the art, or any that may arise in the future.

Although the above descriptions are specific, they should not be considered as limitations on the scope of the invention, but only as examples of the embodiments shown. Many other ramifications and variations are possible within the teachings of the invention. For example, the structure for embracing fingertips can have different shape, size and location; different number of finger spaces can be provided; and the number of buttons and their positions an also be varied. The mouse can be easily adapted for use with a digitizing tablet by providing it with a cross-hair and suitable electronics well known in the art. The separations between the finger spaces can be shaped to allow the finger mouse to be picked up without slipping by closing the fingertips. The rear body can also be shaped to allow the finger mouse be picked up by moving the thumb toward the fingertips. The overall dimensions of the mouse can be changed for accommodating different hand size and shapes. Therefore, the scope of the invention should not be determined by the examples given, but only by the appended claims and their legal equivalents.

I claim:

1. A computer finger mouse for translation over a horizontal stationary surface, comprising:
a generally horizontal bottom surface for stably and translatably positioning said finger mouse over said stationary surface;
an upper body attached on top of said bottom surface for housing needed functional parts, said upper body having a front upper body and a rear upper body; and
a concave structure including a plurality of finger spaces is disposed across the middle of said upper body laterally, said finger spaces are sized and shaped for embrace fingertips of a hand securely and comfortably, so that said finger mouse will follow the movement of said fingertips over said horizontal stationary surface without needing help from the thumb of said hand.

2. The computer finger mouse of claim 1 wherein said front upper body has two buttons disposed on left side and right side, respectively; said buttons can be pressed by one of finger of said hand; if one said button is used to generate left-click signals, then the other said button will be used to generate right-click said signals.

3. The computer mouse of claim 1, further including a scroll wheel disposed at middle of said front upper body for generating scrolling signals when rotated by a said finger of said hand.

4. The computer mouse of claim 1, further including a plurality of buttons disposed aground the edge of said rear upper body for generating said left-click or said right-click signals when pressed by said thumb of said hand.

5. A computer finger mouse for translation over a horizontal stationary surface, comprising:
a generally horizontal bottom surface for stably and translatably positioning said finger mouse over said stationary surface;
an upper body attached on top of said bottom surface for housing needed functional parts, said upper body having a front upper body and a rear upper body; and
a concave structure including a plurality of finger spaces is disposed across the middle of said upper body laterally, said finger spaces are sized and shaped for embrace fingertips of a hand securely and comfortably, so that said finger mouse will follow the movement of said fingertips over said horizontal stationary surface without needing help from the thumb of said hand.

6. The computer mouse of claim 5, further including a scroll wheel disposed at middle of said rear upper body for generating scrolling signals when rotated by said thumb of said hand.

7. The computer mouse of claim 5, further including a plurality of buttons disposed aground the edge of said rear upper body for generating said left-click or said right-click signals when pressed by said thumb of said hand.

8. A computer finger mouse for translation over a horizontal stationary surface, comprising:
a generally horizontal bottom surface for stably and translatably positioning said finger mouse over said stationary surface;
an upper body attached on top of said bottom surface for housing needed functional parts, said upper body having a front upper body and a rear upper body; and
a concave structure including a narrow and continuous finger space is disposed across the middle of said upper body laterally, said finger space is sized and shaped for embrace fingertips of a hand securely and comfortably, so that said finger mouse will follow the movement of said fingertips over said horizontal stationary surface without needing help from the thumb of said hand.

9. The computer finger mouse of claim 8 wherein said front upper body has two buttons disposed on left side and right side, respectively; said buttons can be pressed by one of finger of said hand; if one said button is used to generate left-click signals, then the other said button will be used to generate right-click said signals.

10. The computer mouse of claim 8, further including a scroll wheel disposed at middle of said front upper body for generating scrolling signals when rotated by a said finger of said hand.

11. The computer mouse of claim 8, further including a plurality of buttons disposed aground the edge of said rear upper body for generating said left-click or said right-click signals when pressed by said thumb of said hand.

12. The method of using a computer finger mouse over a horizontal stationary surface for providing mouse signals to a computer, comprising the steps of;
inserting the fingertips of a user's hand into the finger spaces with said hand in a naturally relaxed and curled hand position; said hand and the wrist and the forearm are nearly aligned;
stretching out the fingers to move said finger mouse forward and curling said fingers further to move said finger mouse backward without needing the help from the thumb;
swinging said hand and said forearm rightward or leftward, respectively, to move said finger mouse to the left or the right, correspondingly, without needing the help from said thumb; and
moving said thumb inward to push the buttons on the edge of said finger mouse to perform the right-click or left-click button function.
